(19) United States
(12) Patent Application Publication
(10) Pub. No.: US 2025/0196427 A1
(43) Pub. Date: Jun. 19, 2025

(54) METHOD FOR MANUFACTURING A PIPE MADE OF THERMOFORMABLE FOAM

(71) Applicant: HUTCHINSON AERONAUTIQUE & INDUSTRIE LIMITEE, Montreal (CA)

(72) Inventor: Eric LANTHIER, Montreal (CA)

(21) Appl. No.: 18/856,400

(22) PCT Filed: Apr. 4, 2023
(86) PCT No.: PCT/CA2023/050458

§ 371 Date: Oct. 11, 2024

(30) Foreign Application Priority Data
Apr. 15, 2022 (CA) 3155691

(51) Int. Cl. B29C 51/30; B29C 51/00; B29C 51/42; B29K 105/04; B29L 23/00

(52) U.S. Cl. CPC B29C 51/303; B29C 51/002; B29C 51/42; B29K 2105/04; B29L 2023/22

(57) ABSTRACT

The disclosure relates to a method for manufacturing a pipe made of thermoformable foam, comprising the following steps: a) inserting at least one sheet of thermoformable foam into a shaping mould provided with lips that are configured to engage with one another, the shaping mould being pre-installed in or on a tool that is capable of closing and opening the lips, the at least one sheet having two side edges that connect a first end edge to a second end edge; b) closing the lips of the shaping mould by means of the tool so as to pre-form the at least one sheet into the shape of a pipe in which the side edges thereof are joined together; and c) heating the at least one sheet, with its shaping mould, to a temperature suitable for welding the side edges and for thermoforming the pipe.

### CROSS-REFERENCE TO RELATED APPLICATION(S)

This present application is a national stage application of International Patent Application No. PCT/CA2023/050458, filed Apr. 4, 2023, which claims priority to Canadian Patent Application No. 3155691, filed Apr. 15, 2022, the disclosures of which are hereby incorporated by reference in their entireties.

### TECHNICAL FIELD

This disclosure relates to a method for manufacturing a pipe made of thermoformable foam and to the installation implementing this method. The pipe thus obtained is used in particular to circulate a flow of air within an aircraft.

### TECHNICAL BACKGROUND

The air circuit pipes used in the aircraft are generally made from composite materials, in particular fibres set in a resin. These composite materials have the advantage of having excellent mechanical characteristics, for example in terms of rigidity or mechanical strength, while being light. They can also be combined with materials used as thermal insulators, such as insulating foams. However, for certain applications, particularly the air pipes, the mechanical characteristics are less important. In recent years, therefore, we have seen the emergence of foam pipes, which are flexible by nature, particularly light and that also provide suitable thermal insulation. Because of their flexibility, these foam pipes have the advantage of being easier to install, less fragile and able to adapt to their environment as required.

There are various manufacturing methods for foam pipes.

For example, the document EP-B1-2814660 describes a foam pipe and its manufacturing method, which consists of giving a cylindrical shape to a sheet of foam before joining the side edges of the sheet by gluing, i.e. using an adhesive applied between the side edges.

The document WO-A1-2008/156505 describes a pipe made of thermoplastic foam, based on polyvinylidene fluoride (PVDF) for example, and its manufacturing method. This manufacturing method involves inserting a sheet of thermoplastic foam into a shaping mould comprising a cylindrical mandrel and partitions extending around the mandrel, the sheet being inserted between the mandrel and the partitions. In particular, the sheet is wrapped around the mandrel so that the side edges of the sheet overlap, preforming the pipe. The overlap of the side edges of the sheet and the pipe thus preformed are heated and pressed by the partitions so as to weld the edges of the sheet and thermoform the pipe. Alternatively, a method is also proposed which involves placing two sheets of thermoplastic foam flat in a shaping mould, heating and then evacuating a mould to shape the sheets to the shape of the shaping mould.

The document EP-B1-445592 also describes a pipe made of thermoplastic foam and its manufacturing method, which consists of inserting two preheated foam sheets into a shaping mould, closing the shaping mould so as to weld the side edges of the sheets together before injecting a fluid under pressure between the sheets so as to give them the shape of the shaping mould and thus form a pipe.

The above methods for manufacturing a foam pipe can be expensive and/or complex to implement.

One of the aims of the disclosure is therefore to propose an improved method for obtaining a foam pipe that does not have at least one of the aforementioned disadvantages.

### SUMMARY

A method is therefore proposed for manufacturing a pipe made of thermoformable foam comprising the following steps:
a) inserting at least one sheet of thermoformable foam inside a shaping mould provided with lips that are configured to engage with one another, the shaping mould being preinstalled in or on a tool that is capable of closing and opening the lips, the at least one sheet having two side edges that connect a first end edge to a second end edge;
b) closing the lips of the shaping mould by means of the tool, so as to preform the at least one sheet into the shape of a pipe in which the side edges thereof are joined together; and
c) heating the at least one sheet with its shaping mould to a temperature suitable for welding the side edges and thermoforming the pipe.

In this way, the disclosure ensures simplified and rapid shaping of the foam sheet(s) to form a pipe. In fact, on the one hand, simply closing the shaping mould allows the sheet(s) to be preformed into a pipe, and on the other hand, the thermoformable property of the foam allows the pipe to retain its shape through heating, thus limiting the stresses involved in welding, for example. In addition, the heating step simultaneously allows the pipe to be thermoformed and the side edges of the sheet(s) to be welded together.

The method according to the disclosure may comprise one or more of the characteristics below, taken alone with each other or in combination with each other:
the shaping mould is removable;
step c) is carried out in an oven or proofer;
the method comprises, after step c), a step consisting of receiving an adhesive tape on at least one external weld line formed by welding the side edges and at the level of the end edges so as to reinforce the pipe;
wherein the thermoformable foam is chosen from polyvinylidene fluoride (PVDF), polyphenyl sulphone (PPSU), polyether imide (PEI), polyether sulphone (PESU) or polyethylene terephthalate (PET);
in step b), the lips of the shaping mould are held closed by at least one fastening means;
the method comprises, after step c), a step consisting of dismantling the at least one fastening means;
the shaping mould is made of metal, a metal alloy or a composite material;
the method comprises, prior to step c), and after step b), a step consisting of mounting at least one wedge to at least one end edge of the preformed pipe, the wedge having a section of predefined shape, so that the pipe adopts in section the predefined shape of the wedge;
the cross-section of the wedge is oblong or ellipsoidal;

The disclosure also relates to an installation for implementing the method for manufacturing a pipe made of thermoformable foam as described above, the installation comprising at least:
a shaping mould provided with lips configured to engage with one another,
a tool for closing and opening the lips of the shaping mould,
a heating system;

the shaping mould being pre-installed in or on the tool capable of closing and opening the lips of the shaping mould.

The installation, according to the disclosure, may comprise one or more of the characteristics below, taken in isolation from one another or in combination with one another:
the shaping mould is removable;
the installation comprises at least one fastening means capable of keeping the lips closed;
the heating system is an oven or a proofer.

### BRIEF DESCRIPTION OF THE FIGURES

The disclosure will be better understood with the aid of the following description, given only by way of example and made with reference to the attached drawings in which:

FIG. 1 shows a schematic flat view of a sheet of thermoformable foam,

FIG. 2 shows a schematic perspective view of a straight pipe, in particular formed from at least one sheet of thermoformable foam as shown in FIG. 1,

FIG. 3 shows a schematic perspective view of a pipe with a curvature relative to its longitudinal axis, a pipe in particular formed from two sheets of thermoformable foam,

FIG. 4A shows a schematic cross-sectional view of one embodiment of a shaping mould according to the disclosure, in particular when the shaping mould contains a sheet of thermoformable foam and the shaping mould is open,

FIG. 4B shows a schematic cross-sectional view of the shaping mould in FIG. 4A, in particular when the shaping mould is closed,

FIG. 5A shows a schematic cross-sectional view of another embodiment of a shaping mould according to the disclosure, in particular when the shaping mould contains two sheets of thermoformable foam and the shaping mould is open,

FIG. 5B shows a schematic cross-sectional view of the shaping mould in FIG. 5A, in particular when the shaping mould is closed,

FIG. 6 shows a block diagram of the manufacturing method according to the disclosure,

FIG. 7 shows a schematic partial perspective view of the shaping mould according to the disclosure, in particular when a wedge is fitted to at least one end edge of the preformed pipe.

### DETAILED DESCRIPTION

In the following, reference is made to a thermoformable foam pipe C. The term “pipe” is to be understood as referring to a generally tubular device for conveying a fluid and also for isolating this fluid from an environment external to the pipe. By “pipe,” we also mean an element of an assembly that can form a circuit or network.

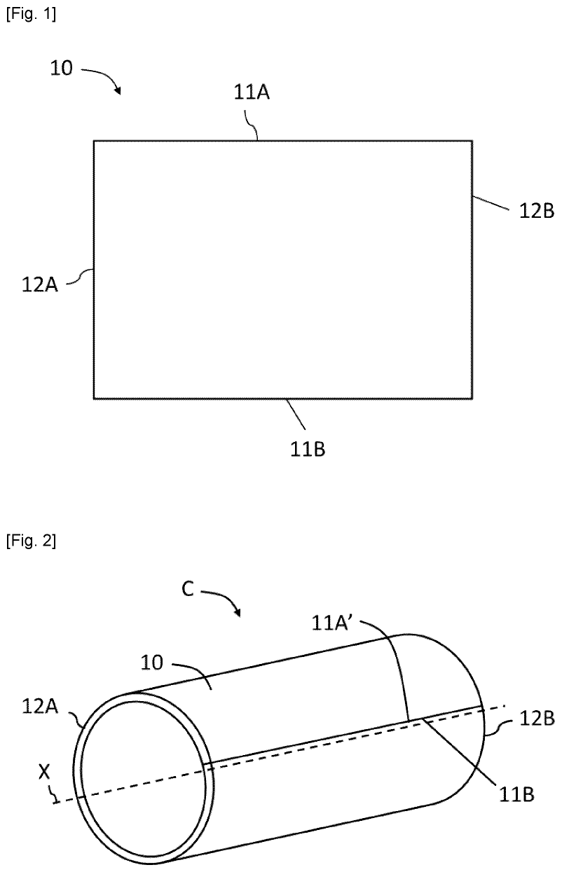

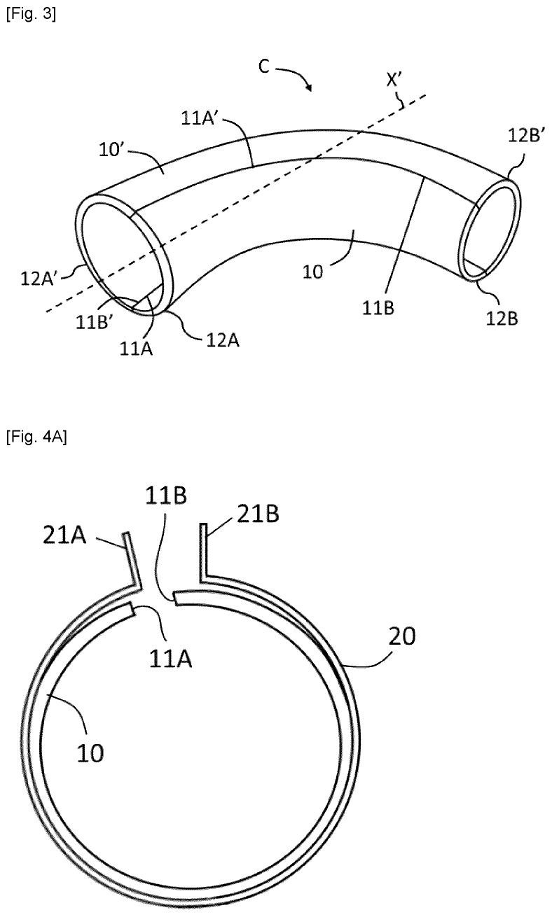

FIG. 1 shows a sheet 10 of thermoformable foam, shown flat in a state considered to be initial, i.e. before any shaping to obtain a pipe C, shown in FIG. 2. In other words, the sheet 10 is the raw material of a pipe C. This sheet 10 comprises a first side edge 11A and a second side edge 11B, each of its two side edges 11A, 11B connects a first end edge 12A to a second end edge 12B.

FIG. 2 shows an example of a pipe C made of thermoformable foam obtained after manufacture in accordance with the disclosure, from at least one sheet 10 of thermoformable foam as shown in FIG. 1. In the example shown in FIG. 2, the pipe C is straight, i.e. the pipe is substantially parallel to its longitudinal axis X and is formed from a single sheet 10 of foam. In this way, the first side edge 11A and the second side edge 11B of the sheet 10 are welded together, and an external weld line and an internal weld line are then formed on the pipe C. In another embodiment, not shown, the straight pipe C can be formed from several sheets 10, for example two sheets 10, 10′. In this way, the first side edge 11A of a first sheet 10 is welded to the second side edge 11B′ of a second sheet 10′, while the second side edge 11B is welded to the first side edge 11A′ of the second sheet 10′. In other words, there are two welds and, for each weld, an external weld line and an internal weld line are then formed on the pipe C.

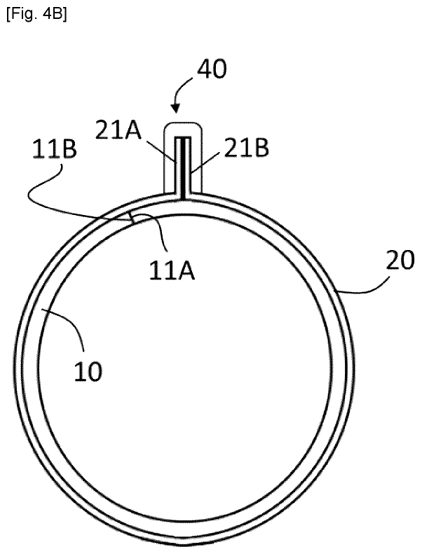

FIG. 3 shows an example of a pipe C of thermoformable foam obtained after manufacture in accordance with the disclosure and having a curvature with respect to the longitudinal axis X′ of the pipe C. A curved pipe C can be formed from at least two sheets 10, 10′ of thermoformable foam. In a case with two sheets 10, 10′, the first side edge 11A of a first sheet 10 is welded to the second side edge 11B′ of a second sheet 10′, while the second side edge 11B is welded to the first side edge 11A′ of the second sheet 10′. Two weld lines S, S′ are then formed on the pipe C. Although not shown, a curved pipe C can be formed from more than two sheets 10, 10′, for example four, thereby increasing the number of weld lines. A pipe C formed with more than two sheets 10, 10′ allows more complex pipe C geometries to be created.

Furthermore, a curved pipe C means that the internal part of the bend is shorter than the external part. Also, the first sheet 10, positioned at the level of the internal part of the bend, is smaller than the second sheet 10′, then positioned at the level of the external part of the bend. The term “dimension” may, for example, refer to the distance separating each side edge 11A, 11B and/or the distance separating each end edge 12A, 12B of each of the sheets 10, 10′. Advantageously, the sheets 10, 10′ are pre-cut.

Advantageously, the material making up the thermoformable foam of each sheet 10 is chosen from, but not limited to, polyvinylidene fluoride (PVDF), polyphenyl sulphone (PPSU), polyether imide (PEI), polyether sulphone (PESU) or polyethylene terephthalate (PET).

The manufacture of a thermoformable foam pipe C as described above can be carried out using a dedicated installation.

This installation comprises a shaping mould 20 with lips 21A, 21B configured to engage with one another. The installation also includes a tool that is capable of closing and opening the lips 21A, 21B of the shaping mould 20, the shaping mould 20 being pre-installed in or on this tool. The installation also comprises a heating system.

Advantageously, the shaping mould 20 is removable. In other words, the shaping mould 20 can be placed in the tool of the installation and can also be removed from it, whether it is open or closed with at least one sheet 10 of thermoformable foam inside.

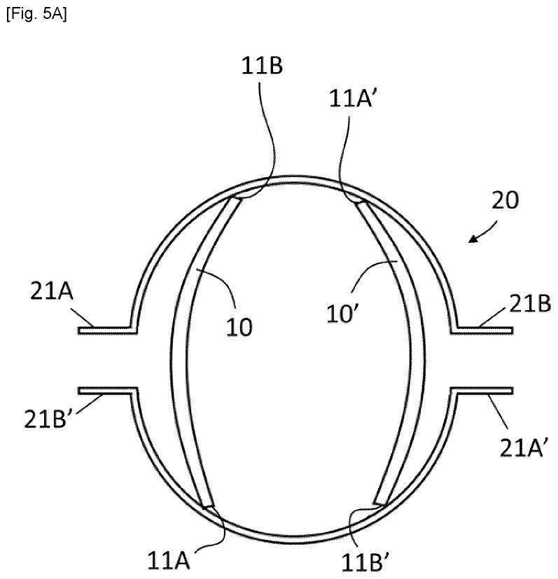

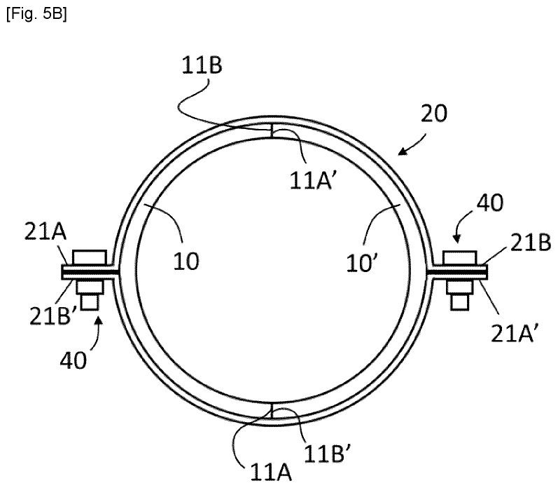

The shaping mould 20 can be in one piece, as shown in FIGS. 4A and 4B, or comprise two parts, as shown in FIGS. 5A and 5B.

When the shaping mould 20 is in two parts, a first part is provided with lips 21A, 21B configured to engage with the lips 21A′, 21B′ of the second part. Alternatively, not shown, the two parts of the shaping mould 20 can be non-symmetrical.

The shaping mould 20 can be made of a metallic material, a metal alloy, for example steel, or a composite material, for example based on carbon fibres embedded in an epoxy resin. All these materials have the advantage of a thermal conductivity that improves the quality of the thermoforming.

In the particular case of a shaping mould 20 made of a material other than metal or a metal alloy, it is preferred that the shaping mould 20 comprises two parts.

The lips 21A, 21B, 21A′, 21B′ of the shaping mould 20 can be secured together by at least one fastening means 40. This fastening means 40 can be, but is not limited to, a screw/nut system or a clamp.

The heating system is configured to allow even temperature distribution.

The heating system may be an oven or a proofer, for example.

In addition, the heating system can be external. In other words, it is not included in the same frame as the closing/opening tool of the shaping mould 20.

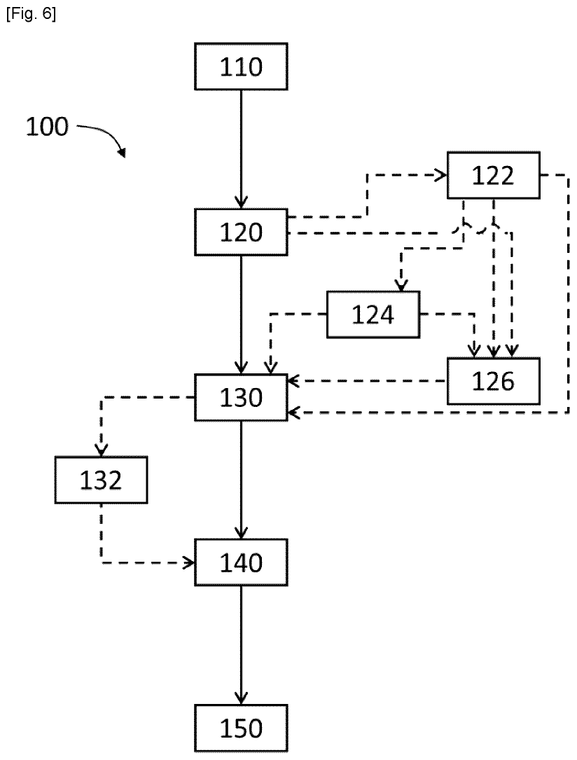

Reference is now made to FIG. 6 showing a block diagram of the method 100 for manufacturing a pipe of thermoformable foam.

In step 110, at least one sheet 10 of thermoformable foam is inserted into a shaping mould 20 as described above. This shaping mould 20 is also pre-installed in or on a tool capable of closing and opening the lips 21A, 21B of the shaping mould 20.

In step 120, the lips 21A, 21B of the shaping mould 20 are closed using the tool. In this way, the at least one sheet 10 is preformed in the form of a pipe C in which the side edges 11A, 11B thereof are joined together. It is understood that the cross-section of the preformed pipe C is then, by default, substantially circular.

A first example of a shaping mould 20 comprising at least one sheet 10 of thermoformable foam is shown in FIGS. 4A and 4B. In this embodiment, the shaping mould 20 is in one piece. In the example shown in FIGS. 4A and 4B, a single sheet 10 is inserted inside the shaping mould 20. It is understood that the orientation or position of the sheet 10 shown in the example of FIGS. 4A and 4B is non-limiting and given by way of illustration. Advantageously, the first side edge 11A and the second side edge 11B are distant from the lips 21A, 21B of the shaping mould 20, and for example placed substantially opposite the lips 21A, 21B of the shaping mould 20.

When the shaping mould 20 is closed, the sheet 10 of thermoformable foam is constrained by the shaping mould 20 and adopts the shape of the latter, which is that of the pipe C. Once the shaping mould 20 is closed, i.e. once the lip 21A and the lip 21B of the shaping mould 20 cooperate with each other, the first side edge 11A and the second side edge 11B of the sheet 10 are pressed together, as can be seen in FIG. 4B. It is understood that more than one sheet 10 of foam can be used with this configuration.

The embodiment shown in FIGS. 4A and 4B is preferred for shaping a straight pipe C, i.e. without any curvature along the longitudinal axis X of the pipe C.

Another example of a shaping mould 20 comprising at least one sheet 10 of thermoformable foam is shown in FIGS. 5A and 5B. In this embodiment, the shaping mould 20 is in two parts. In the particular case of FIGS. 5A and 5B, two sheets 10, 10′ are inserted inside the shaping mould 20. It is understood that the orientation or position of the sheets 10, 10′ shown in the example of FIGS. 5A and 5B is non-limiting and given by way of illustration. When the shaping mould 20 is closed, the sheets 10, 10′ of thermoformable foam are constrained by the shaping mould 20 and adopt the shape of the latter, which is that of the pipe C. Once the shaping mould 20 is closed, i.e. once the lip 21A of each part of the shaping mould 20 cooperates with the lip 21B of the other part of the shaping mould 20, the first side edge 11A and the second side edge 11B of a first sheet 10 are respectively joined to the second side edge 11B′ and to the first side edge 11A′ of the second sheet 10′, as can be seen in FIG. 4B. It is understood that fewer or more than two sheets 10, 10′ of thermoformable foam can be used with this configuration.

The embodiment shown in FIGS. 5A and 5B may be particularly useful for the manufacture of a pipe C which describes a curve along its longitudinal axis X′, as described above.

In an optional step 122, which may be carried out after step 120, the lips 21A, 21B of the shaping mould 20 are held closed by at least one fastening means 40. In this way, the shaping of at least one sheet 10 is improved by limiting the risk of unwanted opening of the shaping mould 20.

When the shaping mould 20 is in a single part, the at least one fastening means 40 is advantageously a clamp, as shown in FIG. 4B.

When the shaping mould 20 is in two parts, the at least one fastening means 40 is advantageously a screw/nut assembly, as shown in FIG. 5B.

In a step 124, taking place after 122 and when the shaping mould 20 is removable, the shaping mould 20 can be removed from the tool.

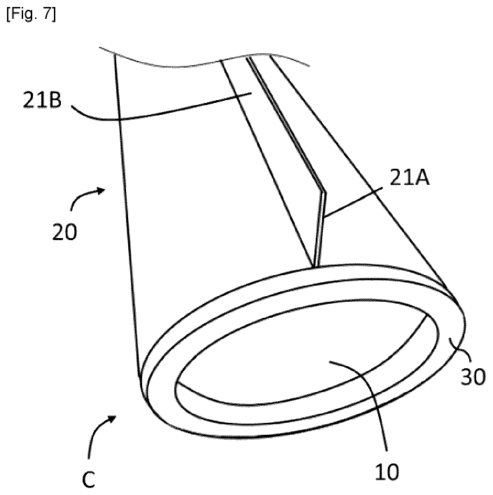

In an optional step 126, which may take place after any of steps 120, 122 or 124, a wedge 30 is fitted to at least one end edge 12A, 12B, and preferably to each end edge 12A, 12B. FIG. 7 shows this wedge 30, once fitted, which has a predefined cross-sectional shape. In particular, the predefined shape of the cross-section of the wedge 30 can be oblong or ellipsoidal. In this way, with the wedge installed, the cross-section of the pipe C will take on the shape of the cross-section of the wedge. It is understood that this wedge enables the shape of the cross-section of the pipe C to be adapted as required, particularly when a circular cross-section is not desired. The wedge 30 is intended to remain fitted to the designated end edge until the pipe C is removed from the shaping mould 20, once the pipe C has been thermoformed. It is understood that carrying out step 126 requires access to at least one of the end edges 12A, 12B. In other words, the tool provides at least one access to these end edges 12A, 12B, in particular when the step 126 is carried out directly following any of steps 120 or 122, i.e. when the shaping mould 20 is not removable.

In a step 130, taking place after any of steps 120, 122, 124 or 126, the shaping mould 20 containing the at least one preformed sheet 10 is heated in a heating system. The heating is carried out at a temperature suitable for welding the side edges 11A, 11B of the sheet 10 and thermoforming the pipe C. Advantageously, the thermoformable foam is heated so as to approach the melting temperature of the material chosen to form the pipe C. In this way, a quality weld and a final shape can be obtained after returning to ambient temperature. On the other hand, the heating temperature must not be too high to prevent the material from going into a molten state, which would cause it to lose its foamed state.

When the shaping mould 20 is removable, it can be placed in a heating system external to the installation. This heating system may be an oven or a proofer.

In a step 132, after step 130, carried out if the optional step 122 has been implemented, the at least one fastening means 40 holding the lips 21A, 21B of the shaping mould 20 closed is dismantled.

In step 140, the pipe C is removed from the shaping mould 20 after the latter has been opened by means of the tool.

At step 150, after removing the pipe C from the shaping mould 20, an adhesive tape can advantageously be applied at least in part to the outer weld line marking the junction of the side edges 11A, 11B. An adhesive tape can also be applied to each of the end edges 12A, 12B. The application of an adhesive tape allows the pipe to be reinforced.

It is clear that the method as described above improves the shaping of the thermoformable foam sheet(s) to form a pipe. This is both simpler and faster. In fact, on the one hand, simply closing the shaping mould allows the sheet(s) to be preformed into a pipe, and on the other hand, the thermoformable property of the foam allows the pipe to retain its shape through heating, thus limiting the stresses involved in welding, for example. In addition, the heating step simultaneously thermoforms the pipe and welds the side edges of the sheet(s) together.

Another advantage is that it allows pipes of different shapes to be shaped, such as straight or curved pipes, for example.

It has also been found that with such a manufacturing method, the loss of material due to the manufacturing method is reduced or substantially the same as with more expensive manufacturing methods. In fact, the thermoformable foam sheet inserted into the shaping mould is the raw material directly shaped. The ratio of the mass of the raw product, i.e. the sheet of thermoformable foam, to the mass of the final product, i.e. the pipe, is close to 1. In other words, there is virtually no loss of material.

1. A method for manufacturing a pipe made of thermoformable foam, comprising the following steps:
a) inserting at least one sheet of thermoformable foam inside a shaping mould provided with lips that are configured to engage with one another, the shaping mould being preinstalled in or on a tool that is capable of closing and opening said lips, said at least one sheet having two side edges that connect a first end edge to a second end edge;
b) closing the lips of the shaping mould by means of the tool, so as to preform said at least one sheet into the shape of a pipe in which the side edges thereof are joined together; and
c) heating said at least one sheet with its shaping mould to a temperature suitable for welding said side edges and for thermoforming the pipe.

2. The method according to claim 1, wherein the shaping mould is removable.

3. The method according to claim 1, wherein step c) is carried out in an oven or proofer.

4. The method according to claim 1, comprising, after step c), a step consisting of receiving an adhesive tape on at least one external weld line formed by welding the side edges and at a level of the end edges so as to reinforce the pipe.

5. The method according to claim 1, wherein the thermoformable foam is chosen from polyvinylidene fluoride, polyphenyl sulphone, polyether imide, polyether sulphone or polyethylene terephthalate.

6. The method according to claim 1, wherein, in step b), the lips of the shaping mould are held closed using at least one fastening means.

7. The method according to claim 6, comprising, after step c), a step consisting of dismantling said at least one fastening means.

8. The method according to claim 1, wherein the shaping mould is made of metal, a metal alloy or a composite material.

9. The method according to claim 8, comprising, prior to step c) and after step b), a step consisting of mounting at least one wedge to at least one end edge of the preformed pipe, the wedge having a section of predefined shape, so that the pipe adopts in section the predefined shape of said wedge.

10. The method according to claim 9, wherein a cross-section of the wedge is oblong or ellipsoidal.

11. An installation for carrying out the method for manufacturing a pipe made of thermoformable foam according to claim 1, comprising at least:
a shaping mould provided with lips configured to engage with one another,
a tool for closing and opening the lips of the shaping mould, and
a heating system;
wherein the shaping mould being pre-installed in or on the tool capable of closing and opening the lips of the shaping mould.

12. The installation according to claim 11, wherein the shaping mould is removable.

13. The installation according to claim 12, comprising at least one fastening means capable of keeping the lips closed.

14. The installation according to claim 13, wherein the heating system is an oven or a proofer.

15. The installation according to claim 11, comprising at least one fastening means capable of keeping the lips closed.

16. The installation according to claim 11, wherein the heating system is an oven or a proofer.

17. The installation according to claim 12, wherein the heating system is an oven or a proofer.

18. The method according to claim 2, wherein step c) is carried out in an oven or proofer.

19. The method according to claim 2, comprising, after step c), a step consisting of receiving an adhesive tape on at least one external weld line formed by welding the side edges and at a level of the end edges so as to reinforce the pipe.

20. The method according to claim 3, comprising, after step c), a step consisting of receiving an adhesive tape on at least one external weld line formed by welding the side edges and at a level of the end edges so as to reinforce the pipe.
